(19) United States
(12) Patent Application Publication
(10) Pub. No.: US 2026/0330138 A1
(43) Pub. Date: Oct. 22, 2026

(54) CLASSIFYING TEXT DATA FROM HETEROGENEOUS SOURCES UNDER DISTRIBUTION SHIFT

(71) Applicant: BeyondTrust Corporation, Johns Creek, GA (US)

(72) Inventors: Darren MAYNARD, Canyon Country, CA (US); Mikhail MAKOUSKI, Denver, CO (US); Kevin LE, Calgary (CA)

(21) Appl. No.: 19/650,056

(22) Filed: Apr. 16, 2026

Related U.S. Application Data
(60) Provisional application No. 63/791,963, filed on Apr. 21, 2025.

(51) Int. Cl. G06F 40/279

(52) U.S. Cl. CPC G06F 40/279

(57) ABSTRACT

The present disclosure generally relates to methods, systems, apparatuses, and non-transitory computer readable media for classifying text data received from a plurality of heterogeneous data sources. An action classification system may receive text data describing actions from one or more computing platforms, normalize the text data, generate embedding vectors by processing the normalized text data through a pretrained language model, and generate predicted category labels for the actions based on the embedding vectors using a classification model. A classification model training system may compute sampling weights for labeled text data to compensate for distributional differences between the labeled text data from a first data source and unlabeled text data from one or more additional data sources, and may train the classification model based on the embedding vectors and the sampling weights.

### CROSS-REFERENCE TO RELATED APPLICATIONS

This application claims the benefit of, and priority to, U.S. Provisional Patent Application No. 63/791,963, filed on Apr. 21, 2025, and entitled “MODEL-ASSISTED LABELING OF MULTI-SOURCE TEXT DATA UNDER DISTRIBUTION SHIFT,” which is hereby incorporated by reference in its entirety as if set forth herein.

### TECHNICAL FIELD

The present disclosure generally relates to machine learning classification of text data, and more particularly, methods, systems, apparatuses, and non-transitory computer readable media for classifying text data received from a plurality of heterogeneous data sources.

### BACKGROUND

Computing platforms expose sets of discrete operations that users and automated processes may perform. Organizations that administer computing infrastructure across multiple platforms may seek to classify these operations according to characteristics such as sensitivity to support security monitoring, access governance, and risk assessment. Individual platforms may expose hundreds or thousands of distinct operations, and organizations utilizing multiple platforms simultaneously may face a large aggregate number of operations requiring classification.

Different computing platforms may use different naming conventions, organizational structures, and documentation formats to describe operations that perform similar functions. Reference data indicating classifications may be available for a subset of operations from one platform but may not be available for operations from other platforms. The reference data that is available may have uneven coverage across different categories of operations. The volume of distinct operations across multiple platforms, combined with the platform-specific conventions used to describe those operations, may make comprehensive classification across platforms challenging.

When data available from one platform differs in its characteristics from data originating at other platforms, extending classifications across platforms may be complicated by these differences. Such differences may arise from variations in how platforms describe their operations, from imbalances in available reference data, and from structural differences in how platforms organize their operations.

Thus, systems and methods for classifying operations from heterogeneous computing platforms that account for differences in data characteristics between platforms are desired.

### BRIEF DESCRIPTION OF THE DRAWINGS

The disclosure can be better understood with reference to the following drawings. The elements of the drawings are not necessarily to scale relative to each other, emphasis instead being placed upon clearly illustrating the principles of the disclosure. Furthermore, like reference numerals designate corresponding parts throughout the several views.

FIG. 1 is a block diagram of an action classification system according to some embodiments of the present disclosure.

FIG. 2 is a flowchart of an action classification process according to some embodiments of the present disclosure.

FIG. 3 is a block diagram of a classification model training system according to some embodiments of the present disclosure.

FIG. 4 is a flowchart of a classification model training process according to some embodiments of the present disclosure.

FIG. 5 is a block diagram of a computing device according to some embodiments of the present disclosure.

FIG. 6 is a block diagram of a computer system according to some embodiments of the present disclosure.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the invention. Instead, they are merely examples of apparatuses and methods consistent with aspects related to the invention as recited in the appended claims. Particular aspects of the present disclosure are described in greater detail below. The terms and definitions provided herein control, if in conflict with terms and/or definitions incorporated by reference.

The present disclosure generally pertains to systems and methods for classifying text data received from a plurality of heterogeneous data sources. More particularly, the disclosure describes systems and methods that generate numerical representations of text data using a pretrained language model and train a classification model using sampling weights that compensate for distributional differences between labeled training data from a first data source and unlabeled target data from one or more additional data sources.

Computing platforms such as cloud service providers, identity and access management systems, and enterprise software platforms may expose sets of operations that authenticated entities may perform. These operations may be referred to as actions, permissions, or API operations depending on the platform. Individual platforms may expose hundreds or thousands of distinct actions. For example, a cloud service provider may expose actions for managing virtual machines, configuring network resources, reading log files, creating user accounts, and modifying access policies. Each action may have associated text data describing the action, including an action name, a description, and documentation explaining the action's function and parameters. Organizations that administer computing infrastructure may utilize multiple platforms simultaneously, and the aggregate number of distinct actions across all platforms an organization uses may number in the tens of thousands.

For security and access governance purposes, organizations may classify actions according to their access level or sensitivity. Actions that read data without modifying it may represent a different security profile than actions that create new resources, which in turn may represent a different security profile than actions that modify access permissions for other users. A set of access level categories may be defined such that all actions within the same category carry a similar risk profile, reducing the problem from individually assessing each action to assigning each to one of a small number of categories. Classifying each action into an access level category may enable organizations to assess the overall privilege level of accounts, groups, and roles based on the actions those entities are authorized to perform. Accounts authorized to perform actions carrying higher access levels may receive additional security controls, monitoring, or periodic access reviews.

Different computing platforms may describe functionally similar actions using different naming conventions, organizational structures, and documentation formats. An action that creates a user account in one platform may be named using one convention while an action that creates a user account in another platform may be named using an entirely different convention, despite both actions performing semantically equivalent functions. One platform may use a colon-separated service prefix followed by a camel case operation name, such as “iam: CreateUser,” while another platform may use a dot-separated hierarchical namespace followed by a forward-slash-separated resource path, such as “Microsoft. Authorization/roleAssignments/write.” The text data associated with actions from different platforms may differ in vocabulary, phrasing, and structural conventions even when describing similar operations. Despite these surface-level differences in how platforms describe their actions, the underlying semantic content of functionally equivalent actions may be similar.

Manual classification of actions by human analysts may be feasible for a single platform or a subset of actions but may not scale to the full set of actions across all platforms an organization uses. Subject matter experts may label a portion of actions from one platform, producing labeled data, but the labeling process may be time-consuming and may require domain expertise to correctly assign categories to actions whose functions are ambiguous or that involve aspects of multiple categories. Coverage of labels within the labeled platform may be incomplete and may vary by category, with some categories having a higher proportion of labeled actions than others. Labeled data from one platform may not be directly applicable to actions from other platforms because the platforms describe their actions differently and may organize their operations according to different structural conventions. Obtaining comprehensive labels for all actions across all platforms may require substantial expert time that may not be available.

To better address these issues, embodiments of the present disclosure provide systems and methods that classify text data from heterogeneous sources by combining semantic representation through a pretrained language model with distribution shift compensation through sampling weights. An action classification system may receive text data from a plurality of data sources and may generate embedding vectors by processing the text data through a pretrained language model, extracting internal representations that capture the semantic content of the text data. A classification model training system may compute sampling weights for labeled text data to adjust the effective training distribution toward the target distribution and may train a classification model on the weighted embeddings. The trained classification model may then generate predicted category labels for unlabeled text data. The pretrained language model may map semantically equivalent text from different platforms to similar regions of the embedding space regardless of platform-specific naming conventions, while the sampling weights may adjust the influence of training examples so that the classifier learns decision boundaries appropriate for the target distribution. Training a lightweight classification model on fixed embedding vectors, rather than fine-tuning the pretrained language model, may consume substantially fewer computational resources and may require fewer labeled training examples. The classification model training system may also augment labeled training data through pseudo-labeling, wherein the trained classification model generates provisional labels for unlabeled data and high-confidence provisional labels are incorporated into the training set.

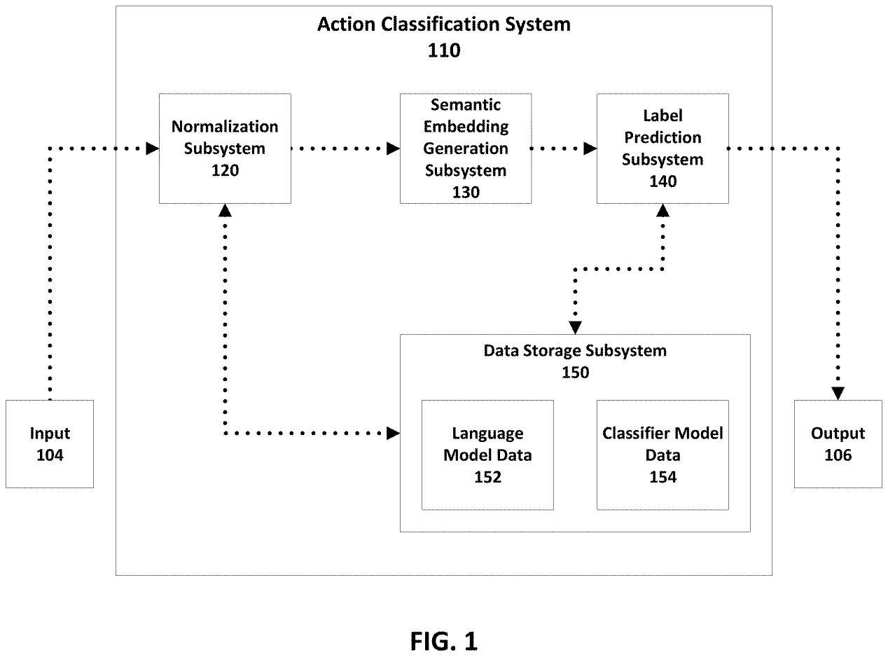

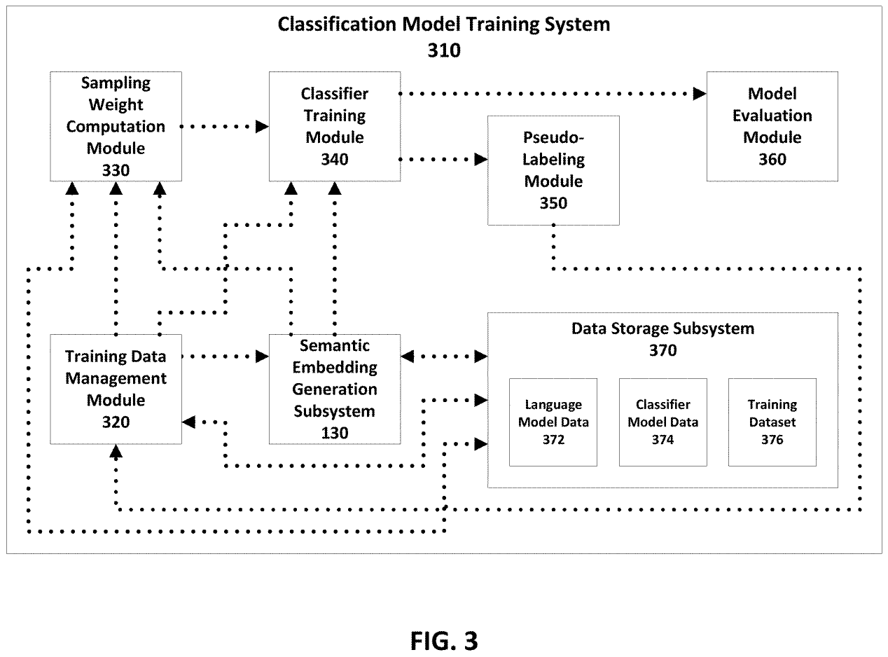

FIG. 1 shows a block diagram of an action classification system according to embodiments of the present disclosure. As shown by the figure, an action classification system 110 may receive input 104 and may produce output 106. The action classification system 110 may comprise a normalization subsystem 120, a semantic embedding generation subsystem 130, a label prediction subsystem 140, and a data storage subsystem 150. The data storage subsystem 150 may comprise language model data 152 and classifier model data 154. The action classification system 110 may operate through a pipeline wherein the normalization subsystem 120 transforms received text data into a standardized form, the semantic embedding generation subsystem 130 generates embedding vectors from the normalized text data, and the label prediction subsystem 140 generates predicted category labels from the embedding vectors, with the data storage subsystem 150 maintaining persistent data supporting these operations. The classification model within the label prediction subsystem 140 may be trained through a classification model training system described in greater detail with reference to FIG. 3.

The action classification system 110 may classify text data describing actions performable within computing platforms into category labels indicating access level or sensitivity. The action classification system 110 may receive text data describing one or more actions from one or more data sources and may generate predicted category labels for those actions. The text data may comprise action names, action descriptions, documentation associated with the actions, or combinations thereof. The category labels may comprise access level categories such as List, Tagging, Read, Write, and Permissions Management. These specific categories are exemplary and other category schemes may be employed depending on the domain and organizational requirements. In some embodiments, the category labels may comprise document sensitivity classifications such as public, internal, confidential, and restricted. In some embodiments, the category labels may comprise issue type classifications for customer service interactions. In some embodiments, the category labels may comprise compliance classifications for regulatory documents. The specific data sources and category schemes may vary by domain while the pipeline of normalizing text data, generating embedding vectors, and generating predicted category labels may be applied across domains where text data from heterogeneous sources requires classification.

The input 104 may comprise text data received from one or more data sources. In some embodiments, the data sources may comprise cloud service providers such as Amazon Web Services, Microsoft Azure, or Google Cloud Platform. In some embodiments, the data sources may comprise identity and access management systems such as Okta, SailPoint, or CyberArk. In some embodiments, the data sources may comprise enterprise software platforms that expose administrative actions. In some embodiments, the data sources may comprise at least one cloud infrastructure platform and at least one identity management platform distinct from the cloud infrastructure platform. The data sources may expose text data through various mechanisms including public documentation, application programming interfaces, or programmatic access to action catalogs. In some embodiments, the action classification system 110 may obtain text data by scraping publicly available documentation from the data sources. In some embodiments, the action classification system 110 may obtain text data through integration with third-party data processing platforms such as distributed data processing frameworks. In some embodiments, text data may be private data that is uploaded to the action classification system 110 by organizations that operate the respective platforms.

In some embodiments, the text data from the data sources may comprise multiple textual fields per action. A single action may have an action name such as “CreateUser” or “ec2:DescribeInstances,” a human-readable description such as “Creates a new IAM user for your AWS account,” and documentation text explaining the action's parameters, required permissions, and effects. In some embodiments, the multiple textual fields may be concatenated into a single text input for processing by the normalization subsystem 120. In some embodiments, different textual fields may be processed separately and the resulting representations combined. The text data exposed by different data sources may use different naming conventions, organizational structures, and documentation formats to describe their respective actions. For example, one cloud service provider may name its actions using a colon-separated service prefix followed by a camel case operation name, while another provider may use a dot-separated hierarchical namespace followed by a forward-slash-separated resource path and operation. These naming conventions are platform-specific and carry structural information about how the platform organizes its services, resources, and operations.

In some embodiments, the text data from different data sources may vary in the amount of descriptive information available per action. Some platforms may provide extensive documentation for each action including detailed descriptions of the action's function, the parameters it accepts, the resources it affects, and the permissions it requires. Other platforms may provide minimal documentation limited to an action name and a brief description. The normalization subsystem 120 and the semantic embedding generation subsystem 130 may operate on whatever text data is available for each action. When extensive documentation is available, the resulting embedding vectors produced by the semantic embedding generation subsystem 130 may encode fine-grained semantic information about the action's function. When minimal documentation is available, the resulting embedding vectors may encode coarser semantic information derived from the words and subwords composing the action name.

The normalization subsystem 120 may transform the text data received as input 104 into a standardized form suitable for processing by the semantic embedding generation subsystem 130. Raw text data from different sources may use different formats, vocabularies, and conventions. The normalization subsystem 120 may perform operations to reduce variation attributable to formatting differences while preserving the semantic content of the text data. In some embodiments, the normalization subsystem 120 may perform tokenization to divide text into individual words or subword units. In some embodiments, the normalization subsystem 120 may perform stop word removal to eliminate common words that carry limited semantic information. In some embodiments, the normalization subsystem 120 may perform punctuation removal. In some embodiments, the normalization subsystem 120 may perform case normalization to convert text to a consistent case. In some embodiments, the normalization subsystem 120 may perform number handling to standardize numerical representations. In some embodiments, the normalization subsystem 120 may perform encoding operations to transform text into numerical representations suitable for input to the semantic embedding generation subsystem 130. The specific normalization operations applied may be selected based on the characteristics of the text data and the requirements of the semantic embedding generation subsystem 130.

In some embodiments, different normalization operations may be applied to different textual fields. Action names may undergo different normalization than documentation text. Action names may use compound identifier conventions such as camel case where words are concatenated with uppercase initial letters, snake case where words are separated by underscores, dot-separated namespaces, or colon-separated prefixes. These conventions may benefit from segmentation into constituent words prior to processing by the semantic embedding generation subsystem 130. Segmentation may involve detecting word boundaries at case transitions in camel case identifiers, splitting on underscore characters in snake case identifiers, splitting on dot or colon delimiters in namespace-style identifiers, or applying combinations of these techniques depending on the detected format. For example, the action name “DescribeInstances” may be segmented into “Describe” and and “Instances,” the action name “Microsoft. Compute/virtualMachines/read” may be segmented into “Microsoft,” “Compute,” “virtual,” “Machines,” and “read.” Documentation text may already be in natural language form and may benefit from stop word removal and punctuation handling rather than compound identifier segmentation.

Platform-specific formatting artifacts such as service prefixes, resource path hierarchies, and version identifiers may convey organizational information specific to the platform but may not contribute to the semantic content that determines which access level category an action belongs to. The normalization subsystem 120 may remove or standardize such artifacts to enable the semantic embedding generation subsystem 130 to generate embedding vectors that more consistently reflect the semantic function of each action rather than the platform-specific conventions used to describe it. In some embodiments, the normalization subsystem 120 may apply platform-specific normalization rules when the data source of each text data entry is known, selecting different segmentation and formatting rules depending on the conventions of the respective platform. In some embodiments, the normalization subsystem 120 may apply heuristic normalization rules that detect and handle common naming conventions without requiring knowledge of the specific data source, detecting camel case, snake case, and delimiter-separated conventions through pattern analysis and applying appropriate segmentation accordingly.

In some embodiments, the normalization subsystem 120 may perform lemmatization or stemming to reduce inflected or derived words to their base or root forms. Lemmatization may map words such as “creates,” “creating,” and “created” to the base form “create,” reducing vocabulary diversity and enabling the semantic embedding generation subsystem 130 to generate more consistent embedding vectors for text data entries that use different inflected forms of the same base word. In some embodiments, the normalization subsystem 120 may expand abbreviations and acronyms commonly used in action names or documentation. Computing platforms may use abbreviated forms such as “desc” for “describe,” “config” for “configuration,” or “mgmt” for “management.” Expanding these abbreviations to their full forms may enable the pretrained language model to produce embedding vectors that more accurately reflect the semantic content of abbreviated action names. In some embodiments, the normalization subsystem 120 may apply different normalization pipelines to text data from different data sources, selecting normalization operations based on the conventions of each respective data source. In some embodiments, the normalization subsystem 120 may apply a uniform normalization pipeline to text data from all data sources when the conventions of the respective data sources are not known in advance.

The semantic embedding generation subsystem 130 may generate embedding vectors from the normalized text data. The semantic embedding generation subsystem 130 may process the normalized text data through a pretrained language model and may extract internal representations from the pretrained language model to produce the embedding vectors. A pretrained language model may be a neural network model that has been trained on a large corpus of text data through self-supervised learning objectives such as next-token prediction or masked language modeling. In next-token prediction, the model may learn to predict each successive token in a text sequence given the preceding tokens. In masked language modeling, the model may learn to predict randomly masked tokens given the surrounding context. Through pretraining on large text corpora encompassing diverse sources including technical documentation, software documentation, and computing-related text, the pretrained language model may develop internal representations that encode the semantic content of input text. Text inputs that describe similar concepts may produce similar internal representations, even when the text inputs use different words or phrasing. In some embodiments, the pretrained language model may comprise a transformer-based architecture. In some embodiments, the pretrained language model may comprise a model such as GPT, BERT, LLAMA, or another pretrained language model architecture. The selection of the pretrained language model may depend on availability, computational constraints, and empirical performance on the text data of interest. The pretrained language model may be stored as language model data 152 within the data storage subsystem 150.

A large language model may be a language model having a number of trainable parameters exceeding a threshold on the order of hundreds of millions of parameters. The specific parameter count that distinguishes a large language model from a smaller language model may vary as model architectures and computational capabilities evolve, and the term large language model as used in this disclosure is not limited to any specific parameter count threshold. A general-purpose large language model may be a large language model that has been pretrained on a broad and diverse text corpus encompassing multiple domains and subject areas, rather than a language model pretrained on a corpus restricted to a single domain or task. Models such as GPT, BERT, and LLaMA are examples of general-purpose large language models.

A general-purpose large language model may have publicly available weights when the pretrained weight values of the model have been made available for acquisition by members of the public, whether through open-source software repositories, model hosting platforms, commercial licensing arrangements, or other distribution mechanisms. The weights may be publicly available regardless of whether access requires payment of fees, agreement to license terms, or registration, provided that the weights are distributed through a mechanism accessible to members of the public generally without requiring a pre-existing relationship with the distributor or membership in a restricted group, and for which the procedures for obtaining access are documented or otherwise ascertainable by prospective recipients.

In some embodiments, the pretrained language model within the semantic embedding generation subsystem 130 may comprise a general-purpose large language model having publicly available weights, and the weights of the pretrained language model as used by the semantic embedding generation subsystem 130 may be the same as the publicly available weights. When the weights are the same as the publicly available weights, the pretrained language model has not been fine-tuned or otherwise modified for the action classification task or for any other downstream task subsequent to the original pretraining.

In some embodiments, the pretrained language model may comprise a transformer-based architecture with stacked self-attention layers and feed-forward layers. Each self-attention layer may compute attention weights among all positions in the input token sequence, enabling the model to capture dependencies between tokens regardless of their distance in the sequence. The attention mechanism may enable the model to determine which tokens in the input are relevant to the representation of each other token, weighting the contributions of all tokens when computing the representation at each position. Earlier layers of the transformer may capture surface-level lexical and syntactic patterns, such as which words tend to appear near one another, while deeper layers may capture higher-level semantic relationships and abstractions, such as that “CreateUser” and “Add-AzADUser” both relate to user account provisioning despite sharing no words in common. The stacking of multiple self-attention and feed-forward layers may progressively refine the representation of the input text from surface-level token patterns to abstract semantic encodings.

The pretrained language model may comprise a final layer, which may be referred to as the output layer or the unembedding layer, that may be configured to produce a probability distribution over a vocabulary of tokens. In a model trained with a next-token prediction objective, the output layer may map the internal representation at each position to a vocabulary-sized vector through a linear transformation followed by a softmax operation, producing a probability for each token in the vocabulary indicating the model's prediction of the next token. The dimensions of the output vector may correspond to individual vocabulary tokens rather than to semantic features. The output of the output layer may therefore encode information about which specific words are likely to follow the input text, rather than encoding the abstract semantic content of the input text in a form suitable for classification.

The semantic embedding generation subsystem 130 may generate the embedding vectors by extracting internal vector representations from an intermediate layer of the pretrained language model with the output layer removed. Rather than using the final output of the pretrained language model, the semantic embedding generation subsystem 130 may extract the vector representation produced by the layer immediately preceding the output layer. This vector representation, referred to as an embedding vector, may encode the semantic content of the input text in a fixed-dimensional numerical vector whose dimensions correspond to learned semantic features rather than to vocabulary tokens. The dimensionality of the embedding vector may depend on the architecture of the pretrained language model and may range from hundreds to thousands of dimensions. For example, a model with a hidden dimension of 4096 may produce embedding vectors of 4096 dimensions. In some embodiments, the semantic embedding generation subsystem 130 may extract representations from a layer other than the layer immediately preceding the output layer. In some embodiments, earlier layers may be selected when the text data of interest is more sensitive to surface-level lexical features. In some embodiments, the semantic embedding generation subsystem 130 may extract representations from multiple layers and concatenate or combine them, producing composite embedding vectors that capture information from multiple levels of abstraction within the pretrained language model.

When the input text comprises a sequence of tokens, the pretrained language model may produce a vector representation for each token in the sequence. The semantic embedding generation subsystem 130 may aggregate these per-token representations into a single fixed-dimensional embedding vector representing the entire input. In some embodiments, the aggregation may comprise selecting the representation of a specific token, such as the first token or a designated classification token. In some embodiments, the aggregation may comprise computing the mean of all per-token representations. In some embodiments, the aggregation may comprise computing a weighted combination of per-token representations. Mean pooling may produce embedding vectors that reflect the overall content of the input text without disproportionate influence from any single token, while selection of a specific token may produce embedding vectors that reflect the model's summary representation at that position. The aggregation method may be selected based on the architecture of the pretrained language model and empirical performance on the classification task.

The embedding vectors produced by the semantic embedding generation subsystem 130 may have the property that text inputs describing semantically similar concepts produce similar embedding vectors regardless of the specific words used. An action named “CreateUser” in one platform and an action named “Add-AzADUser” in another platform may produce embedding vectors that are nearby in the embedding space because both actions relate to user account creation. This property may arise from the pretraining objective, which trains the model to predict text in context. Words and phrases that appear in similar contexts during pretraining may develop similar internal representations. Because semantically equivalent actions from different platforms are typically described using text that occurs in similar documentary contexts, such as documentation about user creation, resource deletion, or permission modification, their internal representations may converge despite surface-level vocabulary differences. Text data entries describing semantically similar actions may produce embedding vectors positioned closer together in the embedding space than embedding vectors corresponding to semantically dissimilar text data entries, even when the similar actions originate from different data sources and the dissimilar actions originate from the same data source. For example, the embedding vectors for “iam:DeleteUser” from one platform and “Remove-AzADUser” from another platform may be closer to each other than either is to the embedding vector for “s3:PutObject” from the first platform, because the first two actions both relate to user deletion while the third relates to data storage.

The degree of semantic convergence may vary depending on the specificity of the actions and the coverage of the pretraining corpus. Actions that relate to common computing concepts broadly discussed in the pretraining corpus, such as user creation, file deletion, or permission assignment, may exhibit strong convergence because text describing these concepts appears frequently and consistently across diverse sources in the pretraining corpus. Actions that relate to platform-specific concepts with limited representation in the pretraining corpus, such as operations on platform-specific resource types or proprietary service features, may exhibit weaker convergence. The quality of the embedding vectors as inputs to a classification model may therefore depend on the overlap between the pretraining corpus and the domain of the text data being classified.

In some embodiments, the pretrained language model may not be fine-tuned for the action classification task. The pretrained language model may be used entirely as pretrained, functioning as a fixed transformation from text to numerical vectors. Fine-tuning a pretrained language model may involve updating millions or billions of model parameters using labeled data specific to the classification task and may require substantial computational resources including specialized hardware such as graphics processing units. For example, a pretrained language model with seven billion parameters may require multiple graphics processing units with tens of gigabytes of memory each to fine-tune. Using the pretrained language model without fine-tuning may avoid these computational requirements. The pretrained language model may function as a fixed semantic encoder whose internal representations are suitable for downstream classification without task-specific adaptation. The embedding vectors may remain fixed regardless of changes to the classification model, enabling the classification model to be retrained, re-weighted, or replaced without regenerating the embedding vectors. In some embodiments, the pretrained language model may itself be replaced with a different pretrained language model, in which case the embedding vectors may be regenerated and the classification model retrained on the new embedding vectors.

In some embodiments, the semantic embedding generation subsystem 130 may generate embedding vectors by processing text data through models other than large language models. In some embodiments, the semantic embedding generation subsystem 130 may generate embedding vectors using autoencoders or variational autoencoders. In some embodiments, the semantic embedding generation subsystem 130 may generate embedding vectors using generative adversarial networks. In some embodiments, the semantic embedding generation subsystem 130 may generate embedding vectors using techniques such as latent semantic analysis or latent Dirichlet allocation. In some embodiments, the semantic embedding generation subsystem 130 may generate word embeddings corresponding to semantic, syntactic, or topical relationships between words, sentences, or other textual units. These alternative embedding generation techniques may produce embedding vectors of different dimensionalities and with different distributional characteristics than embedding vectors produced by large language models.

The label prediction subsystem 140 may receive embedding vectors from the semantic embedding generation subsystem 130 and may produce predicted category labels for the corresponding actions. The label prediction subsystem 140 may comprise a classification model that maps embedding vectors to probability distributions across the set of category labels. A classification model may be a parametric model that, given an input feature vector, computes a probability for each possible category label and outputs the set of probabilities as a probability distribution. The label prediction subsystem 140 may select the category label with the highest probability as the predicted label for each action. For example, given an embedding vector corresponding to an action, the classification model may compute probabilities of 0.02 for List, 0.01 for Tagging, 0.05 for Read, 0.90 for Write, and 0.02 for Permissions Management, and the label prediction subsystem 140 may select Write as the predicted category label.

In some embodiments, the label prediction subsystem 140 may output confidence scores indicating the certainty of each prediction. The confidence scores may comprise the probability assigned to the predicted category, the margin between the highest and second-highest category probabilities, or other measures of prediction certainty. A probability of 0.95 assigned to the predicted category may indicate higher certainty than a probability of 0.35, and a margin of 0.60 between the highest and second-highest categories may indicate higher certainty than a margin of 0.05. In some embodiments, the label prediction subsystem 140 may apply a confidence threshold and may withhold predicted category labels for actions whose highest category probability falls below the threshold, indicating insufficient certainty for automated classification. Actions with withheld predictions may be flagged for manual review by subject matter experts.

In some embodiments, the confidence score may be computed using the entropy of the probability distribution across category labels. Entropy may quantify the uniformity of the probability distribution, with lower entropy indicating that the probability is concentrated on one or a few categories and higher entropy indicating that the probability is spread more uniformly across categories. A prediction with a probability distribution of [0.95, 0.02, 0.01, 0.01, 0.01] may have low entropy and high confidence, while a prediction with a probability distribution of [0.25, 0.22, 0.20, 0.18, 0.15] may have high entropy and low confidence. In some embodiments, the label prediction subsystem 140 may output multiple candidate category labels for a single action when no single category exceeds the confidence threshold, along with their respective probabilities, enabling downstream systems or human reviewers to consider alternative classifications. In some embodiments, the label prediction subsystem 140 may apply different confidence thresholds for different category labels, as some categories may be more reliably predicted than others. Categories with more training examples or more distinctive semantic signatures in the embedding space may warrant lower confidence thresholds than categories that are frequently confused with other categories.

In some embodiments, the classification model within the label prediction subsystem 140 may comprise a logistic regression model. A logistic regression model may map each embedding vector to a probability distribution across the category labels through a learned weight matrix and bias vector followed by a softmax function. In some embodiments, the classification model may comprise a support vector machine. In some embodiments, the classification model may comprise a gradient boosted decision tree model. In some embodiments, the classification model may comprise a random forest model. In some embodiments, the classification model may comprise a neural network with one or more hidden layers. The classification model may comprise fewer trainable parameters than the pretrained language model within the semantic embedding generation subsystem 130. For an embedding dimensionality of 4096 and five categories, a logistic regression model may have approximately 20,480 weight parameters plus five bias parameters, which may be orders of magnitude fewer than the parameters of the pretrained language model. The classification model may be stored as classifier model data 154 within the data storage subsystem 150.

The data storage subsystem 150 may maintain persistent data supporting the operations of the action classification system 110. The data storage subsystem 150 may comprise language model data 152 and classifier model data 154. The language model data 152 may store the pretrained language model or portions thereof used by the semantic embedding generation subsystem 130 to generate embedding vectors. The language model data 152 may comprise the model's architecture definition specifying the number of layers, the hidden dimension, the number of attention heads, and other architectural parameters, the model's pretrained weight values comprising the numerical parameters learned during pretraining, and the model's tokenizer configuration specifying how input text is segmented into tokens for processing by the model. The classifier model data 154 may store the trained classification model used by the label prediction subsystem 140 to generate predicted category labels. The classifier model data 154 may comprise the trained weight matrix and bias vector for a logistic regression model, the learned tree structures for a gradient boosted decision tree model, or the trained weights for a neural network model, depending on the type of classification model employed.

In some embodiments, the data storage subsystem 150 may store precomputed embedding vectors to avoid recomputing embeddings when the same text data entries are processed multiple times. Generating embedding vectors through the pretrained language model may be computationally expensive relative to other operations in the pipeline, and caching previously computed embedding vectors may reduce processing time when text data entries are reprocessed. In some embodiments, the data storage subsystem 150 may store received text data, normalized text data, or configuration data governing the operation of the system. In some embodiments, the data storage subsystem 150 may maintain an index associating each text data entry with its data source of origin, its embedding vector, and its predicted category label, enabling efficient retrieval and querying of classification results. In some embodiments, the data storage subsystem 150 may detect when a data source has added new actions since the last processing and may generate embedding vectors and predicted category labels for the new actions while retrieving cached results for previously processed actions.

The output 106 may comprise predicted category labels generated by the label prediction subsystem 140. In some embodiments, the output 106 may comprise structured output mapping action identifiers to predicted category labels. In some embodiments, the output 106 may comprise both predicted category labels and associated probability distributions or confidence scores for each action, enabling downstream systems to apply their own confidence thresholds or to flag borderline cases for manual review. In some embodiments, the output 106 may be provided to client systems such as privileged access management systems, security information and event management systems, identity governance platforms, or other computing systems that use the classification results for security monitoring, access governance, risk assessment, or compliance purposes.

In some embodiments, the output 106 may be used to assess the privilege levels of accounts, roles, and groups based on the access level categories of the actions those entities are authorized to perform. An account authorized to invoke a set of actions may have a privilege profile derived from the distribution of those actions across the access level categories. An account whose authorized actions are predominantly classified as Read and List may have a lower privilege level than an account whose authorized actions include actions classified as Write or Permissions Management. In some embodiments, the output 106 may enable organizations to identify accounts with elevated privileges, to detect accounts whose permissions exceed their operational requirements, to identify actions that require enhanced authentication, or to generate reports on the distribution of access levels across organizational units. In some embodiments, the output 106 may enable detection of accounts behaving in a manner inconsistent with their classification, such as service accounts performing actions typically associated with human accounts, or non-administrator accounts accessing security administrator applications. In some embodiments, the output 106 may be consumed by automated workflows that trigger remediation actions when accounts are detected with privileges exceeding their operational requirements, such as automatically generating access review requests or restricting access pending review.

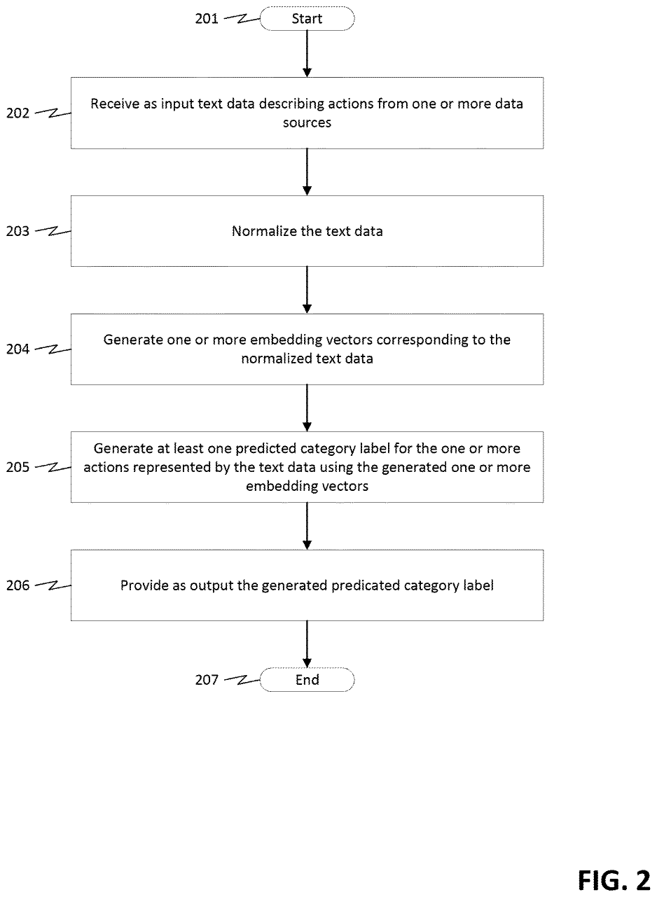

FIG. 2 shows a flowchart of an action classification process according to embodiments of the present disclosure. The process may be performed by the action classification system 110. In some embodiments, the process may be performed by one or more processors executing instructions stored in memory.

At step 202, the action classification system 110 may receive as input text data describing actions from one or more data sources. The text data may describe actions performable within computing platforms such as cloud service providers or identity and access management systems. The text data may comprise action names, descriptions, documentation, or combinations thereof. The one or more data sources may comprise a plurality of computing platforms that use different naming conventions and documentation formats to describe their respective actions. In some embodiments, the text data may be received through application programming interfaces exposed by the data sources. In some embodiments, the text data may be received through scraping of publicly available documentation. In some embodiments, the text data may be uploaded by organizations that operate the respective platforms.

At step 203, the action classification system 110 may normalize the text data. The normalization subsystem 120 may perform operations such as tokenization, stop word removal, punctuation removal, case normalization, number handling, encoding, or segmentation of compound identifiers into constituent words. In some embodiments, the normalization subsystem 120 may apply different normalization operations to different textual fields, applying compound identifier segmentation to action names and natural language text processing to documentation text. The normalization may reduce variation attributable to formatting differences while preserving semantic content. In some embodiments, step 203 may be omitted when the text data is already in a form suitable for processing by the semantic embedding generation subsystem 130.

At step 204, the action classification system 110 may generate one or more embedding vectors corresponding to the normalized text data. The semantic embedding generation subsystem 130 may process the normalized text data through a pretrained language model and may extract internal vector representations from an intermediate layer of the pretrained language model. In some embodiments, the semantic embedding generation subsystem 130 may extract the internal vector representations from a layer immediately preceding the output layer of the pretrained language model. The embedding vectors may encode the semantic content of the text data such that text data entries from different data sources describing semantically equivalent actions produce proximate embedding vectors in the embedding space. In some embodiments, the semantic embedding generation subsystem 130 may aggregate per-token representations into a single embedding vector per text data entry through mean pooling or selection of a specific token position.

At step 205, the action classification system 110 may generate at least one predicted category label for the one or more actions represented by the text data using the generated embedding vectors. The label prediction subsystem 140 may process the embedding vectors through a classification model to produce probability distributions across the set of category labels. The label prediction subsystem 140 may select the category label with the highest probability as the predicted category label for each action. In some embodiments, the label prediction subsystem 140 may generate confidence scores associated with each predicted category label. In some embodiments, the label prediction subsystem 140 may withhold predicted category labels for actions whose confidence scores fall below a confidence threshold.

At step 206, the action classification system 110 may provide as output the generated predicted category labels. The output 106 may comprise the predicted category labels along with associated confidence scores or probability distributions. In some embodiments, the output 106 may be provided to downstream computing systems for security monitoring, access governance, or risk assessment. In some embodiments, the action classification system 110 may perform the steps of the process in an order different from that shown in FIG. 2. In some embodiments, one or more steps may be performed concurrently.

FIG. 3 shows a block diagram of a classification model training system according to embodiments of the present disclosure. As shown by the figure, a classification model training system 310 may comprise a training data management module 320, a sampling weight computation module 330, a classifier training module 340, a pseudo-labeling module 350, a model evaluation module 360, and a semantic embedding generation subsystem 130. The classification model training system 310 may also comprise a data storage subsystem 370. The data storage subsystem 370 may comprise language model data 372, classifier model data 374, and a training dataset 376. The classification model training system 310 may produce a trained classification model for deployment within the label prediction subsystem 140 of the action classification system 110. The semantic embedding generation subsystem 130 shown in FIG. 3 may be the same component shown in FIG. 1, shared between the training and inference configurations, such that the embedding vectors generated during training are produced by the same pretrained language model that generates embedding vectors during inference.

The training data management module 320 may organize text data for training operations. The training data management module 320 may receive text data from data sources and may maintain the distinction between labeled text data and unlabeled text data. The labeled text data may comprise text data entries from a first data source for which category labels have been assigned by subject matter experts. The unlabeled text data may comprise text data entries from the first data source that have not been labeled and text data entries from one or more additional data sources. The training data management module 320 may track which data source each text data entry originated from, as data source membership may be used during sampling weight computation. The training data management module 320 may also track the category labels associated with labeled text data entries, enabling computation of category frequencies within the labeled dataset.

In some embodiments, a small number of hand labels from the additional data sources may be available, as subject matter experts may have classified a limited number of actions from other platforms for evaluation purposes. The training data management module 320 may maintain these evaluation labels separately from the main training labels. Maintaining the evaluation labels separately may prevent their use during training, preserving them as an unbiased evaluation set for assessing how well the trained model generalizes to the target data sources. In some embodiments, the evaluation labels may comprise labels for a random sample of actions from each additional data source.

In some embodiments, the training data management module 320 may maintain metadata associating each text data entry with its data source of origin, its labeled or unlabeled status, its category label if labeled, and the embedding vector generated from its text content. This metadata may enable the sampling weight computation module 330 to access the information needed to compute weights based on data source membership, category membership, and distributional characteristics. The training data management module 320 may store the text data and associated labels and source metadata as the training dataset 376 within the data storage subsystem 370.

For example, in some embodiments the labeled text data may comprise a subset of actions from a first identity and access management platform for which a subject matter expert has assigned access level categories. The coverage of labels may vary across categories, with some categories having a higher proportion of labeled actions than others. In some embodiments, the coverage may range from approximately seven percent to approximately sixty percent depending on the category. The unlabeled text data may comprise the remaining unlabeled actions from the first platform along with actions from one or more additional platforms.

The semantic embedding generation subsystem 130 within the classification model training system 310 may generate embedding vectors for both the labeled and unlabeled text data by processing the text data through the pretrained language model and extracting internal vector representations. Because the embedding vectors encode the semantic content of the text data, text data entries from different platforms that describe semantically equivalent actions may produce similar embedding vectors despite surface-level text differences. An action named “CreateUser” in one platform and an action named “Add-AzADUser” in another platform may produce embedding vectors that are nearby in the embedding space. This property may enable a classification model trained on embeddings from one platform to generalize to embeddings from other platforms to the extent that the semantic relationships between actions and categories are consistent across platforms. The language model data 372 within the data storage subsystem 370 may store the pretrained language model used by the semantic embedding generation subsystem 130.

The sampling weight computation module 330 may compute sampling weights for the labeled text data. Each sampling weight may be a numerical value associated with a labeled text data entry that controls the influence of that entry during training of the classification model. A sampling weight greater than one may cause the corresponding training example to count as multiple observations during training, increasing its influence on the classifier's learned parameters. A sampling weight less than one may cause the corresponding training example to count as a fraction of one observation, decreasing its influence. The sampling weight computation module 330 may compute the sampling weights such that the weighted distribution of the labeled training data approximates the distribution of the unlabeled target data.

The labeled text data and the unlabeled text data may have different distributional characteristics. The labeled text data may originate from a first data source while the unlabeled text data includes data from additional data sources that describe actions using different conventions and that organize their actions according to different structural patterns. The labeled text data may also have been selected for labeling through processes that introduced biases, such as preferential labeling of actions that are operationally prominent or straightforward to classify. The labeled text data may contain different proportions of categories than the target population due to uneven labeling coverage across categories. These distributional differences may cause a classification model trained on unweighted labeled data to learn decision boundaries that do not generalize well to the target data. The sampling weights computed by the sampling weight computation module 330 may compensate for these distributional differences by adjusting the effective influence of each labeled training example.

In some embodiments, the sampling weight computation module 330 may compute inverse probability of sampling weights. The sampling weight computation module 330 may estimate a propensity score for each text data entry, where the propensity score represents the probability that the text data entry belongs to the labeled training set rather than the unlabeled target set. The propensity scores may be estimated using a binary classifier trained to distinguish between embedding vectors from the labeled set and embedding vectors from the unlabeled set. The binary classifier may receive as input an embedding vector and may output a probability that the embedding vector belongs to the labeled training set. Embedding vectors from regions of the embedding space densely populated by labeled training data may receive high propensity scores, while embedding vectors from regions sparsely populated by labeled training data relative to the unlabeled data may receive low propensity scores. For a training example with propensity score p, the inverse probability weight may be proportional to

$$\frac{( 1 - p )}{p} .$$

Training examples from regions of the embedding space that are underrepresented in the training data relative to the target data may thereby receive higher weights, while training examples from overrepresented regions may receive lower weights.

In some embodiments, the sampling weight computation module 330 may compute balanced class weights. The labeled text data may contain different numbers of examples for different categories because the subject matter expert may have labeled unevenly across categories. Balanced class weights may assign weights inversely proportional to the frequency of each category in the labeled text data, such that underrepresented categories receive higher weights and overrepresented categories receive lower weights. For a training dataset containing N total examples and Nₖ examples in category k out of K total categories, the balanced class weight for examples in category k may be proportional to

$$\frac{N}{( K * {N}_{k} )} .$$

Categories with fewer labeled examples may receive higher weights, and the classifier may therefore give more equitable attention to all categories regardless of their representation in the labeled data.

In some embodiments, the sampling weight computation module 330 may compute balanced subpopulation weights. Balanced subpopulation weights may assign weights based on the data source of each training example, adjusting the effective contribution of each data source. When the training data is predominantly from one data source with a small number of hand-labeled examples from other data sources, balanced subpopulation weights may increase the influence of the hand-labeled examples from the other data sources so that the classifier gives proportionate attention to the characteristics of each data source. For example, if the training data comprises one thousand labeled examples from a first data source and ten hand-labeled examples from a second data source, balanced subpopulation weights may assign higher weights to the ten examples from the second data source such that their aggregate influence during training is comparable to the aggregate influence of the examples from the first data source.

In some embodiments, the sampling weight computation module 330 may compute custom subpopulation-specific weighting schemes that combine aspects of subpopulation weighting and class weighting, applying different weight adjustments based on both the data source and the category of each training example. A subpopulation-specific weighting scheme may assign a different set of class weights for each data source, enabling simultaneous correction of both cross-source imbalance and within-source category imbalance. In some embodiments, the sampling weight computation module 330 may employ domain adversarial approaches. In domain adversarial approaches, a discriminator network may be trained to distinguish between embedding vectors from different data sources while sampling weights are derived from the discriminator's outputs, assigning higher weights to training examples that the discriminator finds difficult to assign to a specific data source.

In some embodiments, the sampling weight computation module 330 may perform a grid search across a plurality of available weighting schemes and their parameterizations to select a weighting scheme that produces a highest classification performance metric. The grid search may involve, for each candidate weighting scheme, computing sampling weights according to that scheme, training a classification model with those weights, and evaluating classification performance on hand-labeled data from the target data sources maintained by the training data management module 320. The weighting scheme that produces the highest classification performance metric on the target evaluation data may be selected. The grid search may evaluate inverse probability of sampling weights, balanced subpopulation weights, balanced class weights, custom subpopulation-specific weights, and combinations thereof. The grid search may also vary hyperparameters within each weighting scheme, such as the regularization strength of the propensity score classifier for inverse probability weights or the target proportions for balanced subpopulation weights. In some embodiments, the grid search may evaluate combinations of weighting schemes and classification model types jointly, as the performance of a particular weighting scheme may depend on the type of classification model to which it is applied.

In some embodiments, the sampling weight computation module 330 may apply a configurable threshold to cap a magnitude of the computed sampling weights. Individual training examples with very high sampling weights may cause model instability during training by exerting disproportionate influence on the classifier's learned parameters. Very high sampling weights may arise when a training example has a very low propensity score, producing a very large inverse probability weight. For example, a training example with a propensity score of 0.001 would receive an inverse probability weight proportional to 999, causing that single example to exert as much influence during training as 999 unweighted examples. The sampling weight computation module 330 may apply a configurable maximum threshold such that sampling weights exceeding the threshold are reduced to the threshold value. In some embodiments, the sampling weight computation module 330 may normalize sampling weights after capping such that the weights sum to the number of training examples or to some other target sum. The threshold values may be among the parameters varied during the grid search.

The classifier training module 340 may train a classification model using the embedding vectors corresponding to the labeled text data and the sampling weights computed by the sampling weight computation module 330. The classifier training module 340 may train the classification model by minimizing a weighted loss function. A loss function may quantify the discrepancy between the classification model's predictions and the known category labels for the labeled training examples. In the weighted loss function, the contribution of each training example to the total loss may be scaled by its sampling weight. In some embodiments, the weighted loss function may take the form L=Σwᵢ*l(f(xᵢ),yᵢ), where wᵢ is the sampling weight for the i-th training example, l is the per-example loss function, f(xᵢ) is the model's prediction for the i-th embedding vector, and yᵢ is the corresponding category label. Training examples with higher weights may contribute proportionally larger terms to the total loss and may therefore exert greater influence on the learned parameters of the classification model.

The classifier training module 340 may train the classification model through an iterative optimization procedure. During each iteration, the optimizer may compute the gradient of the weighted loss function with respect to the classification model's parameters, where the gradient of the weighted loss function may be the sum of per-example gradients each scaled by the corresponding sampling weight. The optimizer may then update the model parameters in the direction that reduces the weighted loss. High-weight examples may contribute larger gradient updates than low-weight examples, and the optimizer may converge to parameter values that fit the high-weight examples more accurately than the low-weight examples. Because the sampling weights are configured such that examples resembling the target distribution receive higher weights, the optimizer may converge to parameter values that produce accurate predictions on the target distribution.

In some embodiments, the classification model trained by the classifier training module 340 may be a logistic regression model. Logistic regression models may map embedding vectors to probability distributions across categories through a learned weight matrix and bias vector followed by a softmax function. In some embodiments, the classification model may be a support vector machine. In some embodiments, the classification model may be a gradient boosted decision tree model such as XGBoost or LightGBM. Gradient boosted decision tree models may incorporate sampling weights through weighted splitting criteria, where the impurity reduction at each split may be computed using weighted example counts rather than unweighted counts. In some embodiments, the classification model may be a random forest model. In some embodiments, the classification model may be a neural network with one or more hidden layers. The specific type of classification model may be selected based on the size of the training dataset, the dimensionality of the embedding vectors, computational constraints, and empirical performance. In some embodiments, the classifier training module 340 may train multiple types of classification models and select the model type that achieves highest performance on evaluation data.

The classification model trained by the classifier training module 340 may have substantially fewer trainable parameters than the pretrained language model within the semantic embedding generation subsystem 130. For an embedding dimensionality of 4096 and five categories, a logistic regression model may have approximately 20,480 weight parameters plus five bias parameters. Training a logistic regression model on fixed embedding vectors may be performed on standard computing hardware in seconds or minutes. The grid search performed by the sampling weight computation module 330 may involve training tens or hundreds of classifier instances under different weighting schemes and parameterizations, and the low per-instance training cost may make this search computationally feasible.

In some embodiments, the classifier training module 340 may apply regularization during training. Regularization may constrain the magnitude of the model parameters, reducing the risk that the model fits noise in the training data rather than learning generalizable patterns. For logistic regression models, regularization may take the form of L1 regularization or L2 regularization. The regularization strength may be a hyperparameter varied during the grid search alongside weighting scheme selection.

The pseudo-labeling module 350 may generate provisional predicted category labels for at least a portion of the unlabeled text data using the trained classification model. The pseudo-labeling module 350 may apply the classification model produced by the classifier training module 340 to the embedding vectors corresponding to unlabeled text data entries. The classification model may produce, for each unlabeled text data entry, a probability distribution across the set of category labels. The pseudo-labeling module 350 may evaluate the confidence of each prediction and may select predictions that exceed a confidence threshold. The confidence score may comprise the probability assigned to the highest-probability category, the margin between the highest-probability and second-highest-probability categories, or other measures of prediction certainty. In some embodiments, the confidence threshold may be set such that a substantial majority of selected predictions are correct.

The selected provisional labels and their corresponding text data entries and embedding vectors may be added to the labeled training data, augmenting the training dataset with examples from the target distribution. The classifier training module 340 may then retrain the classification model using the augmented training dataset. The augmented training dataset may include both expert-labeled examples from the first data source and pseudo-labeled examples from the additional data sources. The sampling weight computation module 330 may recompute sampling weights to account for the expanded labeled data, as the distribution of the augmented training data may differ from the distribution of the original labeled data. In some embodiments, the classification model training system 310 may treat pseudo-labeled examples equivalently to expert-labeled examples during subsequent training.

The pseudo-labeling module 350 may operate on regions of the embedding space where the labeled training data may not contain any examples. When the target data contains actions whose embedding vectors occupy regions of the embedding space not represented by any labeled training examples, the sampling weight computation module 330 may not be able to compensate for this absence by adjusting the weights of the existing labeled examples, as there are no labeled examples in those regions to adjust. The pseudo-labeling module 350 may inject examples from these previously unrepresented regions into the training set, providing training signal that sampling weight adjustment alone may not provide.

In some embodiments, the pseudo-labeling process may be iterative. After retraining with a first batch of pseudo-labeled examples, the retrained model may produce different predictions on the remaining unlabeled data, and additional high-confidence predictions may be incorporated in subsequent iterations. Each iteration may produce a retrained model and additional pseudo-labeled examples. The number of iterations may be a configurable parameter. In some embodiments, the iterative process may terminate after a fixed number of iterations, after the number of newly pseudo-labeled examples per iteration falls below a threshold, or after model performance on the evaluation set ceases to improve. In some embodiments, the sampling weight computation module 330 may recompute sampling weights after each pseudo-labeling iteration to account for the updated training distribution.

In some embodiments, the pseudo-labeling module 350 may assign different sampling weights to pseudo-labeled examples than to expert-labeled examples. Expert-labeled examples may receive higher weights than pseudo-labeled examples to reflect the higher reliability of expert labels relative to model-generated labels. In some embodiments, the sampling weight assigned to a pseudo-labeled example may be proportional to the confidence score of the prediction from which the pseudo-label was derived, such that high-confidence pseudo-labels receive weights approaching those of expert labels while lower-confidence pseudo-labels receive proportionally lower weights. In some embodiments, the pseudo-labeling module 350 may implement a curriculum strategy wherein the confidence threshold for accepting pseudo-labels is initially set high and is gradually reduced over successive iterations, incorporating the highest-confidence predictions first and progressively including predictions of lower confidence as the classification model improves. In some embodiments, the pseudo-labeling module 350 may remove previously assigned pseudo-labels in subsequent iterations when the retrained model no longer assigns the same label at or above the confidence threshold, enabling correction of initially incorrect pseudo-labels as the model improves.

The model evaluation module 360 may evaluate the performance of the trained classification model. In some embodiments, the model evaluation module 360 may evaluate performance using hand labels available from the target data sources, maintained separately from the training data by the training data management module 320. Evaluating on target hand labels may provide a direct assessment of how well the trained model generalizes to the target data sources. In some embodiments, the model evaluation module 360 may evaluate performance using held-out labeled data from the first data source.

In some embodiments, the model evaluation module 360 may compute classification metrics such as accuracy, precision, recall, and F1 score, either aggregated across all categories or computed separately for each category. Per-category metrics may be more informative than aggregate metrics when categories have different numbers of examples, as aggregate accuracy may be dominated by categories with the most examples while categories with fewer examples may be obscured. For example, a model may achieve ninety percent aggregate accuracy while achieving only fifty percent accuracy on a minority category. Per-category evaluation may reveal such disparities. In some embodiments, the model evaluation module 360 may compute a confusion matrix showing, for each pair of categories, how many examples with a true label of one category were predicted as the other category. The confusion matrix may reveal systematic misclassification patterns between semantically related categories.

In some embodiments, the model evaluation module 360 may perform cross-validation on the labeled training data from the first data source to estimate classification performance when hand-labeled data from the target data sources is not available or is insufficient for reliable evaluation. In cross-validation, the labeled data may be partitioned into a plurality of folds, and for each fold the classification model may be trained on the remaining folds and evaluated on the held-out fold, with evaluation metrics averaged across folds to produce an estimate of generalization performance. In some embodiments, the cross-validation may be stratified such that each fold maintains the same category distribution as the full labeled dataset, producing more reliable estimates when categories are imbalanced. In some embodiments, the model evaluation module 360 may evaluate the classification model separately for each data source represented in the evaluation data, producing per-source performance metrics in addition to aggregate metrics. Per-source evaluation may reveal that the model generalizes well to some target data sources but poorly to others, which may inform whether additional labeled data from specific sources or source-specific weighting adjustments would improve performance.

The evaluation results from the model evaluation module 360 may inform the grid search performed by the sampling weight computation module 330, as the grid search may use evaluation results to compare candidate weighting schemes and to select the scheme that produces the highest classification performance metric. The evaluation results may also inform decisions about confidence thresholds for pseudo-labeling, classification model type selection, and whether additional expert labeling of specific categories is warranted. The trained classification model may be stored as classifier model data 374 within the data storage subsystem 370 for deployment in the action classification system 110.

In some embodiments, the classification model training system 310 may be executed periodically to retrain the classification model as new data becomes available or as platforms add new actions. In some embodiments, the classification model training system 310 may be executed when a new data source is added, as the distributional characteristics of the target data may change with the addition of the new data source and the sampling weights computed prior to the introduction of the new data source may not be appropriate for the updated target distribution. In some embodiments, the classification model training system 310 may be executed when the model evaluation module 360 detects degradation in classification performance. In some embodiments, the retraining process may reuse previously computed embedding vectors for text data entries that have not changed, generating new embedding vectors for newly added text data entries.

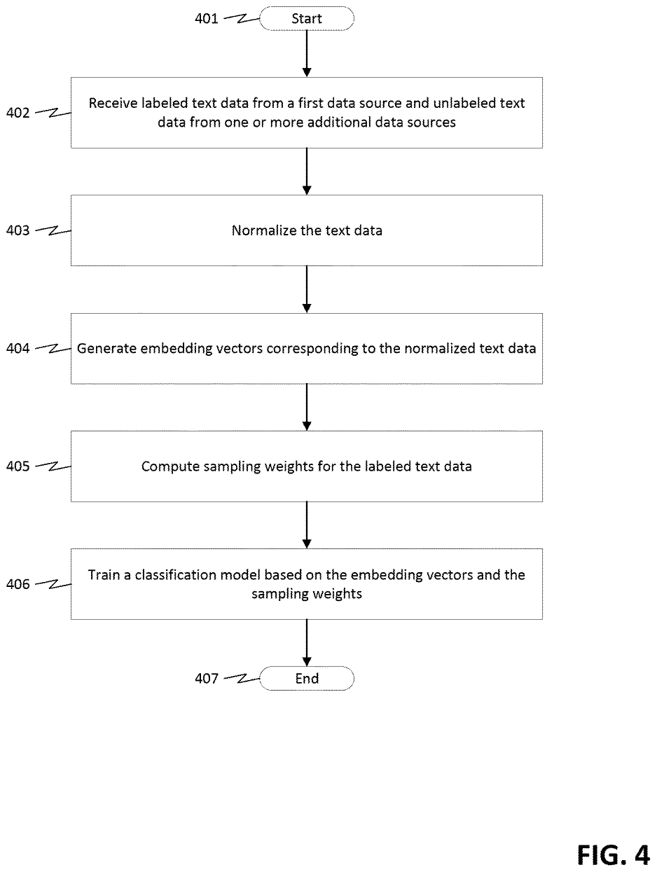

FIG. 4 shows a flowchart of a classification model training process according to embodiments of the present disclosure. The process may be performed by the classification model training system 310. In some embodiments, the process may be performed by one or more processors executing instructions stored in memory.

At step 402, the classification model training system 310 may receive labeled text data from a first data source and unlabeled text data from one or more additional data sources. The labeled text data may associate respective text data entries with respective category labels assigned by subject matter experts. The unlabeled text data may comprise text data entries for which category labels are not available. In some embodiments, the text data may describe actions performable within identity and access management systems, and the category labels may comprise access level categories. In some embodiments, the first data source may comprise a cloud service provider such as Amazon Web Services, and the one or more additional data sources may comprise other cloud service providers or identity management platforms such as Microsoft Azure, Okta, or Google Cloud Platform. In some embodiments, the first data source and the one or more additional data sources may comprise different computing platforms that use different naming conventions and documentation formats.

At step 403, the classification model training system 310 may normalize the labeled text data and the unlabeled text data. The normalization may comprise at least one of tokenization, stop word removal, punctuation removal, case normalization, number handling, or text encoding. In some embodiments, action names using compound identifier conventions may be segmented into constituent words. In some embodiments, platform-specific formatting artifacts such as service prefixes or namespace hierarchies may be removed or standardized. The normalization may reduce variation attributable to formatting differences while preserving semantic content.

At step 404, the classification model training system 310 may generate embedding vectors corresponding to the normalized text data. The classification model training system 310 may process the normalized text data through a pretrained language model and may extract internal representations from an intermediate layer of the pretrained language model. In some embodiments, the output layer of the pretrained language model may be removed and vector representations may be extracted from a layer preceding the removed output layer. In some embodiments, the pretrained language model may not be fine-tuned for the classification task. The embedding vectors may encode the semantic content of the text data such that text data entries from different data sources describing semantically equivalent actions produce proximate embedding vectors.

At step 405, the classification model training system 310 may compute sampling weights for the labeled text data. The sampling weights may adjust the effective distribution of the labeled text data toward the distribution of the unlabeled text data. In some embodiments, the classification model training system 310 may evaluate a plurality of candidate weighting schemes through a grid search and may select the weighting scheme that produces a highest classification performance metric on hand-labeled data from the target data sources. In some embodiments, the candidate weighting schemes may include inverse probability of sampling weights, balanced class weights, balanced subpopulation weights, and custom subpopulation-specific weights. In some embodiments, the classification model training system 310 may apply a configurable threshold to cap the magnitude of individual sampling weights.

At step 406, the classification model training system 310 may train a classification model based on the embedding vectors corresponding to the labeled text data and the computed sampling weights. The classification model may be trained by minimizing a weighted loss function in which the contribution of each training example is scaled by its sampling weight. In some embodiments, the classification model training system 310 may additionally perform pseudo-labeling by applying the trained classification model to at least a portion of the unlabeled text data to generate provisional predicted category labels, selecting provisional predicted labels exceeding a confidence threshold, augmenting the labeled text data with the selected provisional labels, and retraining the classification model using the augmented labeled text data. In some embodiments, the pseudo-labeling may be performed iteratively over a plurality of iterations, with sampling weights recomputed after each iteration.

In some embodiments, the process shown in FIG. 4 may be performed in an order different from that shown. In some embodiments, one or more steps may be performed concurrently. In some embodiments, one or more steps may be omitted. In some embodiments, the process may be re-executed when new data sources are added or when existing data sources expose new actions.

In some embodiments, the process shown in FIG. 4 may produce a trained classification model for classifying actions from identity and access management systems into access level categories comprising List, Tagging, Read, Write, and Permissions Management. In some embodiments, the process may be applied to classify customer service interactions from multiple platforms into issue type categories. In some embodiments, the process may be applied to classify regulatory documents from multiple jurisdictions into compliance categories. The specific data sources, text data, and category labels may vary by domain while the process of generating embeddings, computing sampling weights, and training a weighted classifier may be applied across domains where classification of text data from heterogeneous sources is desired.

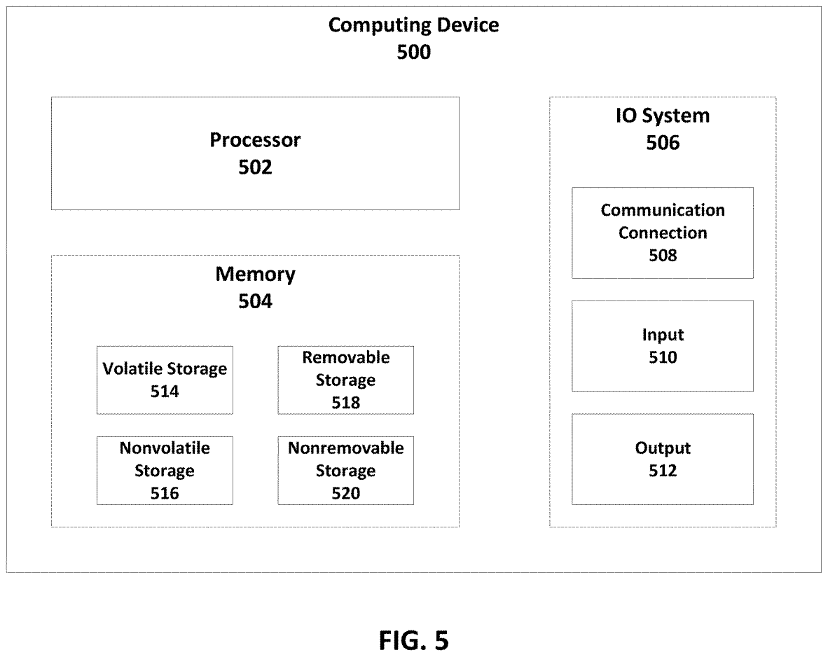

FIG. 5 shows a block diagram of a computing device 500 according to embodiments of the present disclosure. The computing device 500 may comprise hardware or a combination of hardware and software. The functionality to facilitate the operations of the action classification system 110, the classification model training system 310, or both may reside in one or a combination of computing devices 500. The computing device 500 may represent a computing device, a processor, a server, a database, or any appropriate combination thereof. The computing device 500 may be implemented in a single device or multiple devices. Multiple computing devices 500 may be distributed or centrally located. Multiple computing devices 500 may communicate wirelessly, via wired connection, or any appropriate combination thereof.

The computing device 500 may comprise a processor 502 and a memory 504 coupled to the processor 502. The memory 504 may contain executable instructions that, when executed by the processor 502, cause the processor 502 to effectuate operations associated with action classification or classification model training, including operations performed by the normalization subsystem 120, the semantic embedding generation subsystem 130, the label prediction subsystem 140, the training data management module 320, the sampling weight computation module 330, the classifier training module 340, the pseudo-labeling module 350, and the model evaluation module 360.

The computing device 500 may further comprise an IO system 506. The processor 502, the memory 504, and the IO system 506 may be coupled together to allow communications between them. The IO system 506 may comprise a communication connection 508, an input 510, and an output 512. The communication connection 508 may allow the computing device 500 to communicate with other devices or network entities. Communication media may include wired media such as a wired network or direct-wired connection, or wireless media such as acoustic, RF, infrared, or other wireless media. The input 510 may comprise an input device such as a keyboard, mouse, pen, voice input device, or touch input device. The output 512 may comprise an output device such as a display, speakers, or a printer. In various configurations, the IO system 506 may receive or provide information via any appropriate means, such as optical means, electromagnetic means, acoustic means, or a combination thereof.

The memory 504 of the computing device 500 may comprise a storage medium having a concrete, tangible, physical structure. The memory 504 may comprise a volatile storage 514 such as some types of RAM, a nonvolatile storage 516 such as ROM or flash memory, or a combination thereof. The memory 504 may include additional storage such as a removable storage 518 or a nonremovable storage 520 including, for example, tape, flash memory, smart cards, CD-ROM, DVD, or other optical storage, magnetic cassettes, magnetic tape, magnetic disk storage or other magnetic storage devices, USB-compatible memory, or any other medium that can be used to store information and that can be accessed by the computing device 500. The memory 504 may store language model data comprising pretrained language model weights and configuration, classifier model data comprising trained classification model parameters, embedding vectors, training datasets, and computed sampling weights.

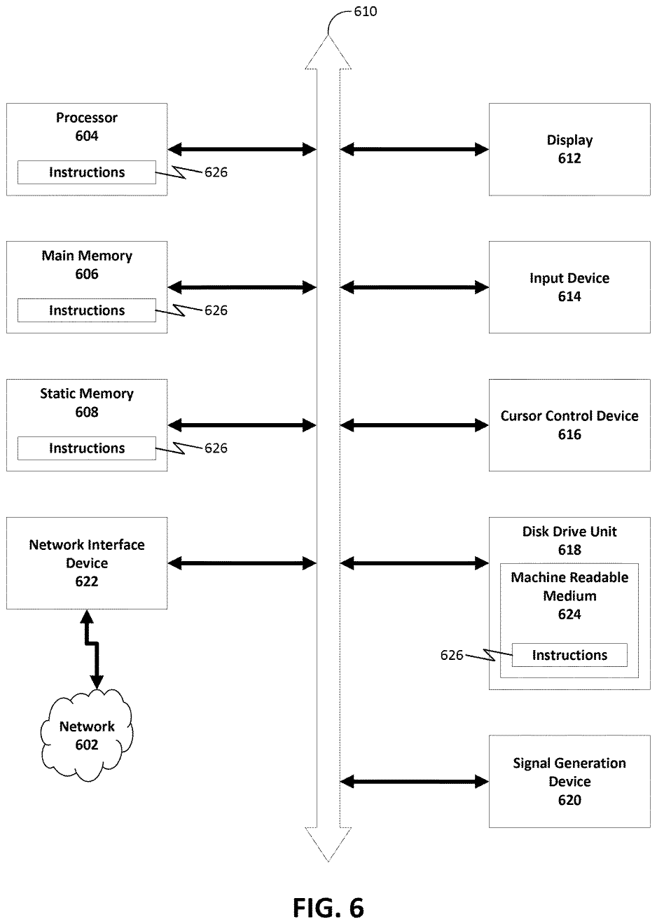

FIG. 6 shows a block diagram of a computer system 600 according to embodiments of the present disclosure. The computer system 600 may comprise a processor 604, a main memory 606, and a static memory 608, which may communicate with each other via a bus 610. The computer system 600 may further comprise a display 612, an input device 614, a cursor control device 616, a disk drive unit 618, a signal generation device 620, and a network interface device 622. The network interface device 622 may be communicatively coupled to a network 602. In a networked deployment, the computer system 600 may operate in the capacity of a server or a client machine in a server-client network environment, or as a peer machine in a peer-to-peer or distributed network environment.

The computer system 600 may comprise a personal computer, a tablet, a smartphone, a laptop computer, a desktop computer, a server computer, a control system, a network router, switch or bridge, or any machine capable of executing a set of instructions that specify actions to be taken by that machine. The term “machine” may also include any collection of machines that individually or jointly execute a set or multiple sets of instructions to perform any one or more of the methods discussed herein. One or more instances of the computer system 600 may operate as the action classification system 110, the classification model training system 310, or components thereof.

The disk drive unit 618 may comprise a machine-readable medium 624 on which may be stored one or more sets of instructions 626 embodying any one or more of the methods or functions described herein. The instructions 626 may also reside, completely or at least partially, within the main memory 606, the static memory 608, or within the processor 604 during execution thereof by the computer system 600. The main memory 606 and the processor 604 may also constitute machine-readable media. The instructions 626 may further be transmitted or received over the network 602 via the network interface device 622.

In some embodiments, a non-transitory computer-readable storage medium including instructions is also provided, and the instructions may be executed by a device, for performing the above-described methods. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM or any other flash memory, NVRAM, a cache, a register, any other memory chip or cartridge, and networked versions of the same. The device may include one or more processors (CPUs), an input/output interface, a network interface, and/or a memory.

The devices, modules, and other functional units described in this disclosure can be implemented by hardware, or software, or a combination of hardware and software. In some embodiments, functions described as being implemented in hardware may instead be implemented in software or a combination of hardware and software. Likewise, in some embodiments, functions described as being implemented in software may instead be implemented in hardware or a combination of hardware and software. If something is implemented by software, it may be stored in a non-transitory computer-readable media, like the computer-readable media described above. Such software, when executed by a processor, may perform the function of the device, module or other functional unit the software is implementing. The above described devices, modules, and other functions units may also be combined or may be further divided into a plurality of sub-units.

Clause 1. A system comprising: a normalization subsystem configured to: receive text data describing one or more actions exposed by one or more computing platforms; and normalize the text data to generate normalized text data; a semantic embedding generation subsystem configured to generate one or more embedding vectors corresponding to the one or more actions by processing the normalized text data through a pretrained language model; a label prediction subsystem configured to generate at least one predicted category label for the one or more actions based on the one or more embedding vectors by using a classification model; and a data storage subsystem configured to: store data associated with the pretrained language model; and store data associated with the classification model.

Clause 2. The system of clause 1 or any other clause herein, wherein the semantic embedding generation subsystem is configured to generate the one or more embedding vectors by extracting internal vector representations from an intermediate layer of the pretrained language model preceding a final output layer of the pretrained language model.

Clause 3. The system of clause 1 or any other clause herein, wherein: the pretrained language model comprises a large language model, wherein the large language model is a general-purpose large language model having publicly available weights; and the weights of the large language model are the same as the publicly available weights of the general-purpose large language model.

Clause 4. The system of clause 1 or any other clause herein, wherein the one or more computing platforms comprise identity and access management systems; and the one or more actions comprise operations performable within the identity and access management systems.

Clause 5. The system of clause 1 or any other clause herein, wherein the at least one predicted category label comprises one of a plurality of access-level categories.

Clause 6. The system of clause 5 or any other clause herein, wherein the plurality of access-level categories comprises List, Tagging, Read, Write, and Permissions Management.

Clause 7. The system of clause 1 or any other clause herein, wherein: the one or more computing platforms comprise a first computing platform and at least one additional computing platform; and the classification model is trained based on: embedding vectors corresponding to labeled text data from the first computing platform; and sampling weights computed to compensate for distributional differences between the labeled text data and unlabeled text data from the at least one additional computing platform.

Clause 8. The system of clause 7 or any other clause herein, wherein the sampling weights comprise at least one of inverse probability of sampling weights, balanced subpopulation weights, balanced class weights, or subpopulation-specific weights.

Clause 9. The system of clause 7 or any other clause herein, wherein the sampling weights are subject to a configurable threshold on weight magnitude.

Clause 10. The system of clause 1 or any other clause herein, wherein: the classification model is trained at least in part using pseudo-labels generated by: applying the classification model to text data for which category labels are not available to generate predictions with associated confidence scores; and selecting predictions having confidence scores exceeding a confidence threshold.

Clause 11. The system of clause 1 or any other clause herein, wherein normalizing the text data comprises at least one of tokenization, punctuation removal, stop word removal, number handling, or encoding the text data into numerical representations.

Clause 12. A method, comprising: receiving text data describing one or more actions exposed by one or more computing platforms; normalizing the text data to generate normalized text data; generating one or more embedding vectors corresponding to the one or more actions by processing the normalized text data through a pretrained language model; generating at least one predicted category label for the one or more actions based on the one or more embedding vectors by using a classification model; and providing as output the at least one predicted category label.

Clause 13. The method of clause 12 or any other clause herein, wherein generating the one or more embedding vectors comprises extracting internal vector representations from an intermediate layer of the pretrained language model preceding a final output layer of the pretrained language model.

Clause 14. The method of clause 12 or any other clause herein, wherein: the one or more computing platforms comprise a first computing platform and at least one additional computing platform; and the classification model is trained using sampling weights computed based on distributional differences between labeled text data from the first computing platform and unlabeled text data from the at least one additional computing platform.

Clause 15. A method, comprising: receiving labeled text data describing one or more actions exposed by a first computing platform; receiving unlabeled text data describing one or more actions exposed by one or more additional computing platforms; normalizing the labeled text data and the unlabeled text data to generate normalized text data; generating embedding vectors corresponding to the normalized text data by processing the normalized text data through a pretrained language model; computing sampling weights for the labeled text data based on distributional characteristics of the unlabeled text data; and training the classification model based on: the embedding vectors corresponding to the labeled text data; and the computed sampling weights.

Clause 16. The method of clause 15 or any other clause herein, further comprising: generating pseudo-labels for at least a portion of the unlabeled text data by using the classification model; and retraining the classification model using the pseudo-labels.

Clause 17. The method of clause 15 or any other clause herein, wherein computing the sampling weights comprises performing a grid search across a plurality of weighting schemes to select a weighting scheme that produces a highest classification performance metric.

Clause 18. The method of clause 15 or any other clause herein, wherein computing the sampling weights comprises applying a configurable threshold to cap a magnitude of individual sampling weights.

Clause 19. The method of clause 15 or any other clause herein, wherein the sampling weights are constrained based on a configurable weight magnitude threshold.

Clause 20. The method of clause 15 or any other clause herein, wherein the first computing platform and the one or more additional computing platforms comprise identity and access management systems.

Clause 21. A non-transitory computer-readable storage medium storing instructions that, when executed by one or more processors, cause the one or more processors to: receive text data describing one or more actions exposed by one or more computing platforms; normalize the text data to generate normalized text data; generate one or more embedding vectors corresponding to the one or more actions by extracting internal vector representations from an intermediate layer of a pretrained language model; and generate at least one predicted category label for the one or more actions based on the one or more embedding vectors by using a classification model, wherein: the one or more computing platforms comprise a first computing platform and at least one additional computing platform; and the classification model is trained using sampling weights computed to compensate for distributional differences between labeled text data from the first computing platform and unlabeled text data from the at least one additional computing platform.

In some places reference is made to standards, including standard methods of performing some task. These standards are revised from time to time, and, unless explicitly stated otherwise, reference to standards in this disclosure refer to the most recent published standard as of the time of filing.

The terms “about” and “approximately” shall generally mean an acceptable degree of error or variation for the quantity measured given the nature or precision of the measurements. Typical, exemplary degrees of error or variation are within 20%, preferably within 10%, more preferably within 5%, and still more preferably within 1% of a given value or range of values. Numerical quantities given in this description are approximate unless stated otherwise, meaning that the term “about” or “approximately” can be inferred when not expressly stated.

Ordinal numbers or terms such as “first” and “second” are used only to differentiate an entity or operation from another entity or operation, and do not require or imply any actual relationship or sequence between these entities or operations. Thus, a first feature or element could be termed a second feature or element, and similarly, a second feature or element could be termed a first feature or element without departing from the teachings of the present disclosure. Moreover, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items.

As used herein, unless specifically stated otherwise, the terms “or” and “at least one of” encompasses all possible combinations, except where infeasible. For example, if it is stated that a component may include “A or B,” then, unless specifically stated otherwise or infeasible, the component may include “A,” “B,” or “A and B.” As a second example, if it is stated that a component includes “at least one of A, B, or C,” then, unless specifically stated otherwise or infeasible, the component may include “A,” “B,” “C,” “A and B,” “A and C,” “B and C,” or “A, B, and C.” This same construction applies to longer lists (e.g., “may include A, B, C, or D”).

As used herein, the singular forms “a”, “an,” and “the” are intended to include the plural forms as well, unless the context clearly indicates otherwise.

Any statements in this disclosure criticizing or disparaging aspects of the prior art are not intended to indicate that what is claimed excludes any of those criticized or disparaged aspects of the prior art.

Any given element or step of the embodiments disclosed above may be embodied in a single element or step or may be embodied in multiple elements or steps. Moreover, any given element or step of the embodiments disclosed above may be combined and embodied in single element or step or may be combined and embodied in multiple elements or steps.

Any sequence of steps shown in the various figures is only for illustrative purposes and does not necessarily indicate that embodiments of the present disclosure are limited to any particular sequence of steps. As such, steps performed by various embodiments of the present disclosure can be performed in a different order while implementing the same method.

In the foregoing specification, embodiments have been described with reference to numerous specific details that can vary from implementation to implementation. Certain adaptations and modifications of the described embodiments can be made. Other embodiments can be apparent to those skilled in the art from consideration of the specification and practice of the invention disclosed herein. It is intended that the specification and examples be considered as exemplary only, with a true scope and spirit of the invention being indicated by the following claims. It is also intended that any sequence of steps shown in the figures is only for illustrative purposes and are not intended to indicate that the embodiments of the present disclosure are limited to any particular sequence of steps. As such, those skilled in the art can appreciate that these steps can be performed in a different order while implementing the same method.

Now, therefore, the following is claimed:

1. A system comprising:
a normalization subsystem configured to:
receive text data describing one or more actions exposed by one or more computing platforms; and
normalize the text data to generate normalized text data;
a semantic embedding generation subsystem configured to generate one or more embedding vectors corresponding to the one or more actions by processing the normalized text data through a pretrained language model;
a label prediction subsystem configured to generate at least one predicted category label for the one or more actions based on the one or more embedding vectors by using a classification model; and
a data storage subsystem configured to:
store data associated with the pretrained language model; and
store data associated with the classification model.

2. The system of claim 1, wherein the semantic embedding generation subsystem is configured to generate the one or more embedding vectors by extracting internal vector representations from an intermediate layer of the pretrained language model preceding a final output layer of the pretrained language model.

3. The system of claim 1, wherein:
the pretrained language model comprises a large language model, wherein the large language model is a general-purpose large language model having publicly available weights; and
the weights of the large language model are the same as the publicly available weights of the general-purpose large language model.

4. The system of claim 1, wherein the one or more computing platforms comprise identity and access management systems; and the one or more actions comprise operations performable within the identity and access management systems.

5. The system of claim 1, wherein the at least one predicted category label comprises one of a plurality of access-level categories.

6. The system of claim 5, wherein the plurality of access-level categories comprises List, Tagging, Read, Write, and Permissions Management.

7. The system of claim 1, wherein:
the one or more computing platforms comprise a first computing platform and at least one additional computing platform; and
the classification model is trained based on:
embedding vectors corresponding to labeled text data from the first computing platform; and
sampling weights computed to compensate for distributional differences between the labeled text data and unlabeled text data from the at least one additional computing platform.

8. The system of claim 7, wherein the sampling weights comprise at least one of inverse probability of sampling weights, balanced subpopulation weights, balanced class weights, or subpopulation-specific weights.

9. The system of claim 7, wherein the sampling weights are subject to a configurable threshold on weight magnitude.

10. The system of claim 1, wherein:
the classification model is trained at least in part using pseudo-labels generated by:
applying the classification model to text data for which category labels are not available to generate predictions with associated confidence scores; and
selecting predictions having confidence scores exceeding a confidence threshold.

11. The system of claim 1, wherein normalizing the text data comprises at least one of tokenization, punctuation removal, stop word removal, number handling, or encoding the text data into numerical representations.

12. A method, comprising:
receiving text data describing one or more actions exposed by one or more computing platforms;
normalizing the text data to generate normalized text data;
generating one or more embedding vectors corresponding to the one or more actions by processing the normalized text data through a pretrained language model;
generating at least one predicted category label for the one or more actions based on the one or more embedding vectors by using a classification model; and
providing as output the at least one predicted category label.

13. The method of claim 12, wherein generating the one or more embedding vectors comprises extracting internal vector representations from an intermediate layer of the pretrained language model preceding a final output layer of the pretrained language model.

14. The method of claim 12, wherein:
the one or more computing platforms comprise a first computing platform and at least one additional computing platform; and
the classification model is trained using sampling weights computed based on distributional differences between labeled text data from the first computing platform and unlabeled text data from the at least one additional computing platform.

15. A method, comprising:
receiving labeled text data describing one or more actions exposed by a first computing platform;
receiving unlabeled text data describing one or more actions exposed by one or more additional computing platforms;
normalizing the labeled text data and the unlabeled text data to generate normalized text data;
generating embedding vectors corresponding to the normalized text data by processing the normalized text data through a pretrained language model;
computing sampling weights for the labeled text data based on distributional characteristics of the unlabeled text data; and
training the classification model based on:
the embedding vectors corresponding to the labeled text data; and
the computed sampling weights.

16. The method of claim 15, further comprising:
generating pseudo-labels for at least a portion of the unlabeled text data by using the classification model; and
retraining the classification model using the pseudo-labels.

17. The method of claim 15, wherein computing the sampling weights comprises performing a grid search across a plurality of weighting schemes to select a weighting scheme that produces a highest classification performance metric.

18. The method of claim 15, wherein computing the sampling weights comprises applying a configurable threshold to cap a magnitude of individual sampling weights.

19. The method of claim 15, wherein the sampling weights are constrained based on a configurable weight magnitude threshold.

20. The method of claim 15, wherein the first computing platform and the one or more additional computing platforms comprise identity and access management systems.
